(19) United States
(12) Patent Application Publication
(10) Pub. No.: US 2013/0035979 A1
(43) Pub. Date: Feb. 7, 2013

(54) CROSS-PLATFORM AUDIENCE MEASUREMENT WITH PRIVACY PROTECTION

(71) Applicant: Michael Tenbrock, Columbia, MD (US)

(72) Inventor: Michael Tenbrock, Columbia, MD (US)

(73) Assignee: Arbitron, Inc., Columbia, MD (US)

(21) Appl. No.: 13/195,399

(22) Filed: Aug. 1, 2011

(51) Int. Cl. G06Q 10/00

(52) U.S. Cl. 705/7.29

(57) ABSTRACT

Systems and methods for performing market research studies using techniques for maximizing privacy for persons. Exposure data relating to television, radio, outdoor advertising, digital signage, newspapers and magazines, retail store visits, interne usage and panelists' beliefs and opinions relating to consumer products and services are received along with facial image data that is secured to allow only partial reproduction of the image data and/or otherwise minimize further identification of the person beyond a market study identity. Further privacy features are employed to allow for blind participation in a given market study.

### TECHNICAL FIELD

The present disclosure is directed to processor-based audience analytics. More specifically, the disclosure describes systems and methods for cross-correlating data measurements relating to specific persons, groups, their location(s), purchasing habits, and exposure to various types of media. Additional privacy measures are introduced to ensure data security during the analytics process.

### BACKGROUND INFORMATION

As new advertising mediums develop and numerous existing mediums evolve, there is an increased interest in studying and processing these mediums to determine their effectiveness on the general public, and determining behavioral patterns that may or may not be based on specific advertisements provided in a specific medium. Consumers are exposed to a wide variety of media, including television, radio, print, outdoor advertisements (e.g., billboards), digital signage, and other forms. Numerous surveys and, more recently, electronic devices are utilized to ascertain the types of media to which individuals and households are exposed. The results of such surveys and data acquired by electronic devices (e.g., ratings data) are currently utilized to set advertising rates and to guide advertisers as to where and when to advertise.

Current audience estimates are based on mediums such as radio and television, as well as computer and mobile handset usage, where devices, such as the Arbitron Personal People Meter™ and/or software track users to establish content ratings data and/or media usage. Other electronic devices, such as bar code scanners and RFID tags are employed to track, among other things, consumer purchasing behavior and market data. Still other technologies, such as the Intel® “AIM Suite” allows retailers to track audience exposure to digital signage by using facial recognition systems configured near digital signage kiosks.

The various types of media and market research information identified above, as well as others not mentioned, are produced by different companies and usually are presented in different formats, concerning different time periods, different products, different media, etc. It is therefore desired to reconcile the data from multiple sources and/or representing different information in an accurate and meaningful way to derive information that is both understandable and useful. One proposed solution is disclosed in U.S. patent application Ser. No. 12/425,127 to Joan Fitzgerald, titled “Cross-Media Interactivity Metrics,” assigned to the assignee of the present application, which is incorporated by reference in its entirety herein. The solution provides an effective means for tracking household exposure and market data and converting the data accurately to a person level.

However, additional capabilities are needed to encompass a wider scope of technologies including facial recognition, biometrics and the like. Additionally, privacy-related features would need to be incorporated to protect users from having sensitive data leaked to unwanted entities. It is therefore desirable to introduce a new system for overcoming some of these shortcomings.

### SUMMARY

Under certain embodiments, computer-implemented methods and systems are disclosed for processing data in a tangible medium for market studies involving members of the general public and/or market study participants having a market study “identity” that is separate from the participant's real identity. Exposure data is received, where the exposure data includes data relating to a person's exposure to media in a plurality of different mediums during a period of the market study. The mediums include, but are not limited to, television, radio, outdoor advertising, digital signage, newspapers and magazines, retail store visits, internet usage and panelists' beliefs and opinions relating to consumer products and services. Transaction data is also received, where the transaction data includes data relating to one or more commercial transactions (e.g., credit/debit card transactions) attributed to the participant during the period of the market study or other predetermined time periods.

In addition, image identification data is received that includes image data of the participant, e.g., a facial image, wherein the image data is received in a secure format that prevents full reproduction of the image data or minimizes further identification of the participant beyond the market study identity. The facial identification data is then used to perform a recognition algorithm, to either identify a specific participant, or compare the facial identification data to a generic census demographic facial image dataset to extract demographic information. This identification and/or demographic identification is then taken and processed with the exposure data and transaction data to determine correlations between exposure to media and transactions attributed to the participant.

### BRIEF DESCRIPTION OF THE DRAWINGS

The present invention is illustrated by way of example and not limitation in the figures of the accompanying drawings, in which like references indicate similar elements and in which:

FIG. 1 illustrates a system for capturing and measuring data from the general public under an exemplary embodiment;

FIG. 2 illustrates an exemplary embodiment of a video capture and retail analysis system that may be incorporated in the system of FIG. 1;

FIG. 3A illustrates an exemplary process in which privacy-based modifications may be made to video data captured in the embodiment of FIG. 2;

FIG. 3B illustrates an exemplary process in which privacy-based modifications made in the embodiment of FIG. 3A may be accessed by authorized personnel;

FIG. 4 illustrates an exemplary process through which identification and/or demographic data may be collected utilizing the privacy-based modifications illustrated in FIG. 3A; and

FIG. 5 illustrates a system through which audience measurement and analytics is performed under an exemplary embodiment.

### DETAILED DESCRIPTION

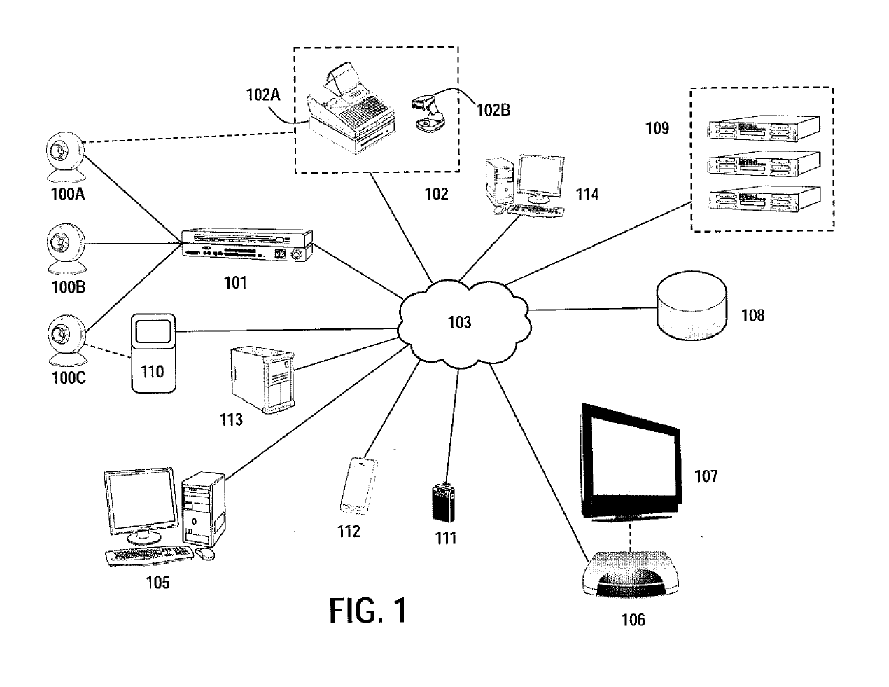

FIG. 1 is an exemplary system diagram communicating and/or operating through packet-switched network 103 embodied as a digital communications network that groups transmitted data, irrespective of content, type, or structure into suitably sized blocks or packets. The network over which packets are transmitted is a preferably a shared network which routes each packet independently from all others and allocates transmission resources as needed. While not specifically illustrated as such, network 103 may comprise a plurality of packet-switched networks such as wide area networks (WANs) and/or local area networks (LANs). In an alternate embodiment, network 103 may be embodiment as a “cloud” for enabling convenient, on-demand network access to a shared pool of configurable computing resources (e.g., networks, servers, storage, applications, and services) that can be rapidly provisioned and released with minimal management effort or service provider interaction.

The system of FIG. 1 includes a plurality of digital cameras (100A-100C) that are operatively coupled to network appliance 101, which in turn communicates captured video and/or photographs from any of digital cameras 100A-100C. Under one embodiment, network appliance 101 may be configured as a “thin client,” meaning that network appliance 101 may enable Internet access and certain processing, but applications are typically housed on one or more servers 113, where they are accessed by the appliance and other devices. When remote management/cost issues are a concern, the thin client configuration may be advantageous. However, it is understood by those skilled in the art that other devices, such as computer workstations, may easily be substituted for network appliance 101. In addition to providing still and/or video images, network appliance 101 is preferably configured to provide additional data relating to the images, such as time-stamps, location data, and the like.

Each of the digital cameras 100A-100C may exist in a stand-alone configuration. Preferably, at least some of the digital cameras are communicatively coupled and in close physical proximity to other devices, such as point-of-sale (POS) terminal 102 and/or digital signage kiosk 110. In the case of a digital signage kiosk 110, a digital camera 100C would be assigned to the kiosk to record images of individuals or groups facing the kiosk. As is known in the art, digital signage is a form of electronic display that shows information, advertising and other messages. Digital signs (such as LCD, LED, plasma displays, or projected images) can be placed in public and private environments, such as retail stores and corporate buildings. Digital signage displays are typically controlled by processors or basic personal computers (not shown in FIG. 1 for the purposes of brevity). Advertising using digital signage is a form of out-of-home advertising in which content and messages are displayed on digital signs with a common goal of delivering targeted messages to specific locations at specific times. This is often referred to as “digital out of home” or abbreviated as DOOH. Digital signage kiosk 110 includes a communication link that allows signage-related data to be transferred to and from the kiosk via network 103.

In the illustration of FIG. 1, digital camera 100A is associated with a point of sale (POS) terminal 102 (also known as point of purchase terminal). Point of sale terminal 102 includes a register 102A that typically comprises a processor, monitor, cash drawer, receipt printer, customer display and a barcode scanner, as well as a debit/credit card reader and signature capture screen. Additional devices, such as a supplementary card reader 102B is preferably used to register users as part of a “membership” and/or “rewards” service being offered by a retailer via shopper cards/loyalty cards. Data generated from POS terminal 102 is processed using one or more back-office computers 114, and is discussed in further detail below. Preferably, digital camera 100A would be configured to record images of individuals or groups facing a checkout counter at POS terminal 102. POS terminal 102 additionally includes a communication link to allow transaction data to be communicated to from terminal 102 via network 103.

Under one embodiment, all data transmitted to and from network appliance 101, digital signage kiosk 110, and POS terminal 102 is handled and stored in data center 109. Data center 109 is preferably configured to handle switching, routing, distribution and storage of data. Alternately, data center 109 could be supplemented or replaced by stand-alone servers or other suitable devices to accomplish these tasks. Mass storage may be provided in data center 109 or may be arranged outside the data center as illustrated in 108.

As briefly mentioned above, the system of FIG. 1 incorporates exposure data being generated in various user devices, including personal computer 105, cell phone/PDA 112, audio meter 111, and set-top-box (STB) 106. Exposure data from personal computer 105 includes data relating to online behavior including web browsing and transactions, online video consumption, “widget” or “App” consumption, online ad impression and the like. The same exposure can be obtained from cell phone/PDA 112 using methods known in the art. For audio meter 111 (e.g., Arbitron Personal People Meter™), exposure data is generated using audio code detection and/or signature matching techniques on ambient audio captured on the device, typically via a microphone. Examples of such techniques are set forth in U.S. Pat. No. 5,764,763 and U.S. Pat. No. 5,450,490 to Jensen, et al., each entitled “Apparatus and Methods for Including Codes in Audio Signals and Decoding,” which are incorporated herein by reference in their entirety. It is understood by those skilled in the art that audio code detection and/or signature matching may instead be incorporated into cell phone/PDA, and thus obviating the need for separate devices (111, 112) for this function. STB data includes content data relating to content displayed on television 107. This content may include program data and interactive programming data accessed by the user.

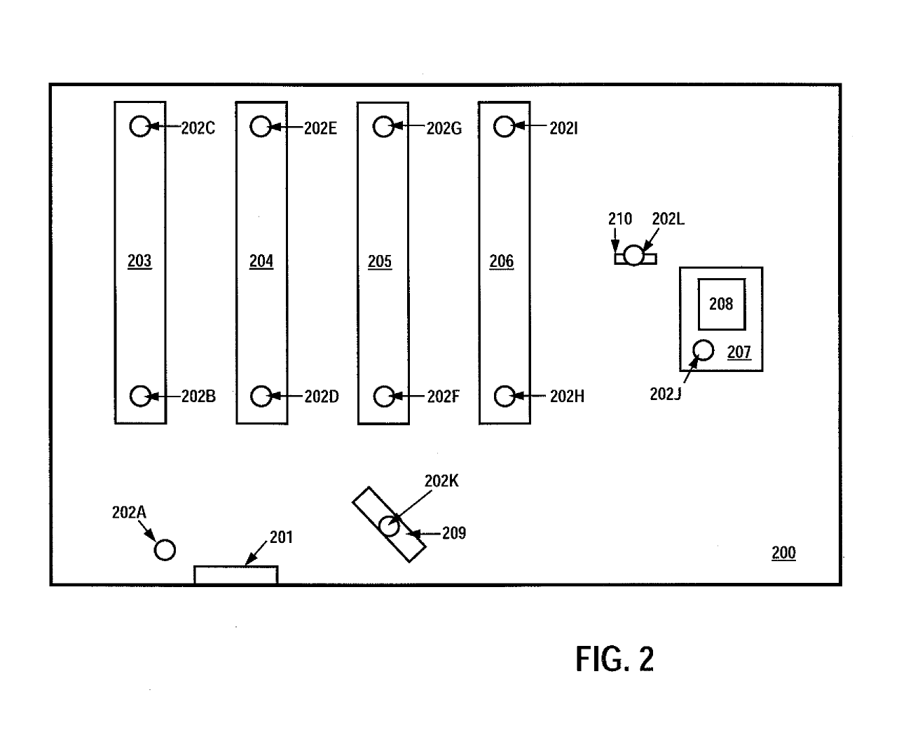

Turning to FIG. 2, a retail application is provided for an exemplary store 200. Here, shoppers enter store 200 via entrance 201, where facial features are captured via digital camera 202A (“facial data”). Digital signage kiosk 209 is also equipped with camera 202K for recording facial images and/or video positioned in proximity to kiosk 209. As shoppers move throughout aisles 203-206 of store 200, cameras 202B-202I are positioned in advantageous areas to capture facial images or video in order to identify and track shoppers throughout store 200. When a shopper approaches POS terminal 207, camera 202J is configured to capture facial images and/or video as well. Similar to kiosk 209, digital signage 210 may also be positioned near POS terminal 207, equipped with camera 202L in order to capture facial images/video as well.

The system of FIG. 2 is advantageous for detecting shopper behavior within a store. Under one preferred embodiment each camera in 202B-202I may be assigned to a specific good or class of good (e.g., canned fruit, cleaning supplies, etc.); as cameras 202B-202I capture facial data, shoppers may be identified as being in the proximity of a specific good or class of good. Additionally, shopper may be interested in a particular advertisement being displayed on kiosk 209. When the shopper faces the kiosk to view the advertisement, camera 202K will capture the facial data as well. Similarly, camera 202L may capture facial data of the shopper when viewing an advertisement on digital signage kiosk 210 near POS terminal 207.

When a shopper pays for the goods purchased in the above example, camera 202J captures facial data to register the presence of the shopper at POS terminal 207. Under a preferred embodiment, the images and/or video generated by each of cameras 202A-202L are time-stamped in order to register the time in which facial data is captured. POS terminal 207 typically includes a computer, monitor, cash drawer, receipt printer, customer display and a barcode scanner, and also includes a debit/credit card reader. Additionally, POS terminal can include a weight scale, integrated credit card processing system, a signature capture device and a customer pin pad device, as well as touch-screen technology and a computer may be built in to the monitor chassis for what is referred to as an “all-in-one unit.” Any and all of these devices may be present at POS terminal 207 and are depicted in FIG. 2 as block 208. Collectively, blocks 207 and 208 are also referred to herein as a “POS system.”

The POS system software is preferably configured handle a myriad of customer based functions such as sales, returns, exchanges, layaways, gift cards, gift registries, customer loyalty programs, quantity discounts and much more. POS software can also allow for functions such as pre-planned promotional sales, manufacturer coupon validation, foreign currency handling and multiple payment types. Data generated at the POS system may be forwarded to back-office computers to perform tasks such as inventory control, purchasing, receiving and transferring of products to and from other locations. Other functions include the storage of facial data, sales information for reporting purposes, sales trends and cost/price/profit analysis. Customer information may be stored for receivables management, marketing purposes and specific buying analysis.

Under a preferred embodiment, data generated from the POS system is associated with the facial data. In cases where a shopper pays cash, transaction identification data is associated with facial data registered at or near a time period in which the transaction was completed. Specific goods or items are automatically imported into a specific transaction using Universal Product Codes (UPC) or other similar data. For credit/debit transactions (or similar cards, such as cash cards and/or reward cards), data is taken from the card via a card reader in a manner similar to that specified in ISO/IEC standards 7810, ISO/IEC 7811-13 and ISO 8583. While not entirely necessary, if there is prior consent from a shopper, shopper data, which includes demographic data, may be obtained from the debit/credit card. Additionally or alternately, demographic information for the shopper may be takes from the facial data in a manner described in U.S. Pat. No. 7,267,277, which is incorporated by reference in its entirety herein.

Under normal circumstances, the preservation of shopper privacy will be important, not only for the transaction data, but for the facial data as well. For transaction data, conventional cryptographic processes are useful in preserving privacy. However, for video and/or image data, the high bitrates from the digital cameras make cryptographic encoding a complex process, which may not be desirable. In such a case, bit scrambling of the facial data may be employed, where the bit scrambling transforms coefficients and motion vectors during the encoding process to blur or black-out out the entire image. Preferably, bit scrambling should be used in specific regions of interest (ROI; also known as areas-of-interest, or AOI) in order to prevent identification of certain objects, while preserving the overall scene.

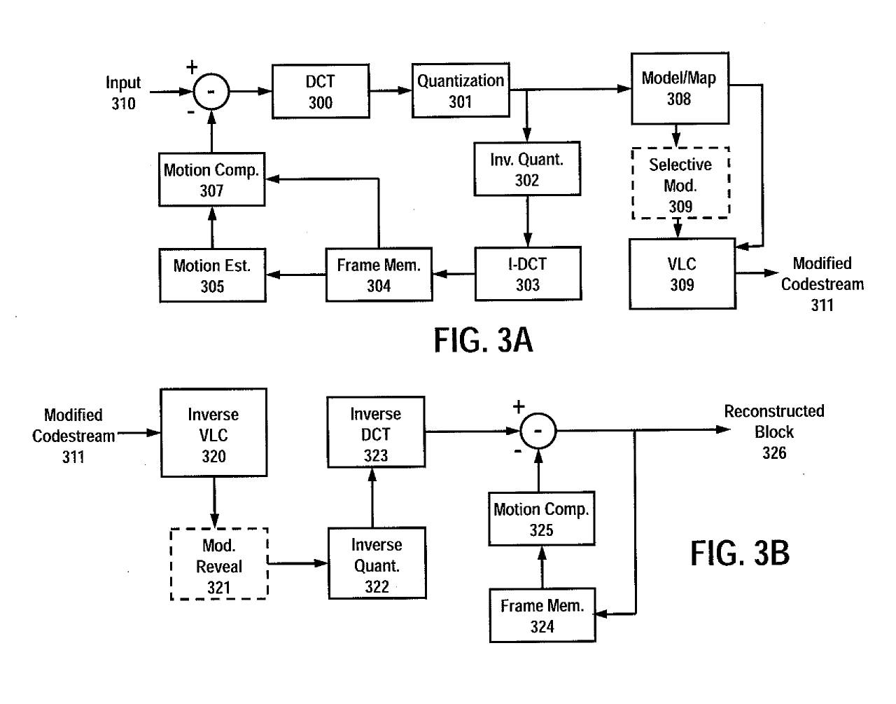

Turning to FIG. 3A, an exemplary process is disclosed for incorporating privacy features into captured video data. Most video coding schemes are based on transform-coding, where frames are transformed using an energy compaction transform such as discrete cosine transform (DCT) or discrete wavelet transform (DWT). The resulting coefficients are then entropy coded using techniques such as Huffman or arithmetic coding. Face detection (i.e., the ROI of captured video) may be implemented using binary pattern classification, where the content of a given part of an image is transformed into features, after which a classifier trained on example faces decides whether a potential ROI of the image is a face. Exemplary algorithms for facial detection includes the Viola-Jones object detection framework, neural network-based face detection (Rowley, Baluja & Kanade), and others.

In the embodiment of FIG. 3A, faces detected from incoming video 310 are subject to a motion compensated block-based DCT 300. Each frame is subdivided into a matrix of macro-blocks (e.g., 16×16), where each macro-block comprises a plurality (e.g., 8×8) of luminance blocks and a plurality (e.g., 8×8) of chrominance blocks. The DCT is performed on each of luminance and chrominance blocks, resulting in a multitude (e.g., 64) of DCT coefficients having at least one DC coefficient and a plurality of AC coefficients. The DCT coefficients are then quantized 301 using a predetermined quantization matrix to achieve a desired compression. In the case of moving video, a motion compensation loop is preferably employed for error reduction, where inverse quantization 302 and inverse DCT 303 are preformed, and motion estimation 305 and motion compensation 307 is executed based on video data stored in frame memory 304. Under one embodiment, the motion compensation loop estimates motion vectors for each macroblock (e.g., 16×16), and depending on the motion compensation error, determines a subsequent coding mode (e.g., intra-frame coding, inter-frame-coding with or without motion compensation, etc.).

Continuing with the example of FIG. 3A, after quantization 301, frame coefficients are subjected to modeling and/or mapping 308, where landmarks or features may be extracted, such as the relative positions, size, and/or shape of the eyes, nose, cheekbones, and jaw. These features may subsequently used for generating demographic data and/or matching with other images having similar features. Under an alternate embodiment, frame coefficients can be compressed, thus saving only the data in the image that is useful for face detection. In 309, the frame is subjected to selective modification, which allows the system to selectively blur or block facial images to prevent identification. Under one example, a blurring process can be implemented by scrambling predetermined AC coefficients in a DCT block by pseudo-randomly flipping the sign of each selected AC coefficient. Preferably, the shape of a scrambled region should be restricted to match the DCT block boundaries, and the amount of scrambling can be adjusted by reducing the number of coefficients used.

The scrambling of coefficients may be driven by a pseudo-random number generator initialized by a seed value. The generator should preferably be cryptographically strong and produce non-deterministic outputs to make the seed material unpredictable. The seed value may then be encrypted and inserted into the code stream 311, via video client (VLC) 309, as private data. Alternately, the seed value may be transmitted over a separate channel. In order to unscramble the codestream, the shape of the ROI may also be transmitted as metadata, either in the private data of the codestream, or in a separate channel.

On the decoder side, FIG. 3B illustrates an exemplary decoder that receives the modified codestream 311 from FIG. 3A, which passes through inverse VLC 320 to a modification reveal module 321, which is responsible for inverse scrambling of the frames from FIG. 3A. Here, only authorized users would be able to unscramble the coefficients resulting from entropy coding prior to the motion compensation loop of FIG. 3A, which allows for a fully reversible process. If a user is authorized, the key resulting from the seed value and ROI size allows the decoder to unscramble the region to reconstruct the frame(s), and subsequently subject them to inverse quantization 322 and inverse DCT 323 to generate a reconstituted block 326. Depending on the coding used, motion compensation 325 may additionally be applied to the reconstituted frame(s) based on reference frames stored in frame memory 324. In an alternate embodiment, one-way scrambling algorithms may be used to ensure that the image(s) cannot be reconstituted (e.g., random numbers and/or temporary keys).

The example in FIGS. 3A-3B is particularly suited for formats such as MPEG video, and more particularly MPEG-4 video. It is understood by those skilled in the art that the embodiment is equally applicable to other DCT-based schemes, such as Motion JPEG or Advanced Video Coding (AVC). Furthermore, the principles disclosed above can be readily applied to DWT-based systems, such as Motion JPEG 2000, where the scrambling is effected just prior to arithmetic coding.

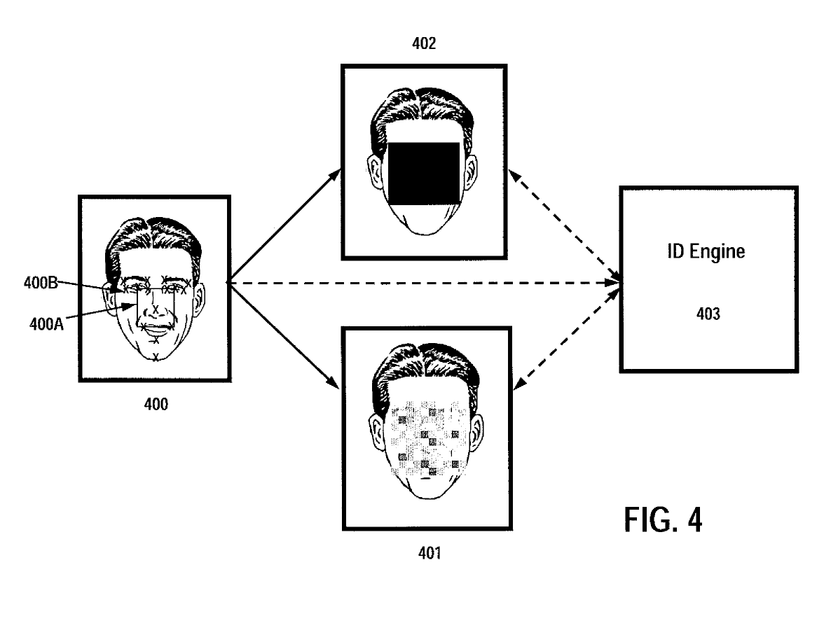

Turning to FIG. 4, an exemplary illustration of facial data processing and identification is provided. As discussed above, when landmarks and/or features are extracted in the model/mapping module 308, example of FIG. 3A, after quantization 301, frame coefficients are subjected to modeling and/or mapping 308, where landmarks or features may be extracted. In facial image 400, a facial boundary 400A is created to model a facial area defined by the eyes, nose and mouth. Additionally, numerous facial objects 400B (shown as “X's” in FIG. 4) are identified and mapped across the facial image (e.g., left eye, nose, right mouth corner, etc.). The facial model and objects can then be used for facial recognition in identification engine 403, which may be based on geometric recognition, which looks at distinguishing features, or photometric recognition, which is a statistical approach that distills an image into values and compares the values with templates to eliminate variances. Exemplary recognition algorithms include Principal Component Analysis with Eigenface, Linear Discriminate Analysis, Elastic Bunch Graph Matching, Hidden Markov Model, and Neuronal Motivated Dynamic Link Matching.

If image scrambling is used (see ref 309 in FIG. 3A), the produced image is illustrated in 401. If image blocking is used, the resultant image is illustrated in 402. For obvious reasons, image modifications, such as scrambling, should be executed after landmarks and/or features have been extracted and stored. The software in identification engine 403 is preferably based on a general-purpose computer programming language, such as C or C++, and preferably includes algorithm scripts, such as Lua, to provide extensible semantics. As features are extracted from image 400, engine 403 creates a feature pool to identify individual and demographic characteristics. The features can be defined as structure kernels summarizing the special image structure, where the kernel structure information is coded as binary information. The binary information can be used to form patterns representing oriented edges, ridges, line segments, etc. During a training phase, features are selected and weighted, preferably using an Adaptive Boosting algorithm or other suitable technique. Other exemplary techniques for feature extraction and image recognition are disclosed in U.S. Pat. No. 7,715,597 title “Method and Component for Image Recognition” and U.S. Pat. No. 7,912,253, title “Object Recognition Method and Apparatus Therefor,” each of which is incorporated by reference in their entirety herein.

By using any of the aforementioned techniques, facial identification may be carried out in an efficient and secure manner. Additionally, once the identity of an individual is made, valuable demographic data may be imported into the system of FIG. 1 for audience measurement purposes, and utilized in a system such as that described in U.S. patent application Ser. No. 12/425,127 to Joan Fitzgerald, titled “Cross-Media Interactivity Metrics,” mentioned above and incorporated by reference herein. In certain instances, individual facial data may not be available for recognition purposes. In such a case, facial data may be compared to a generic census dataset in order to extract approximated demographic characteristics (e.g., sex, race, age group, etc.) and even capture facial expressions from the mapped landscapes to approximate moods of shoppers (e.g., happy, angry, etc.) as they pass by displays and digital signage kiosks.

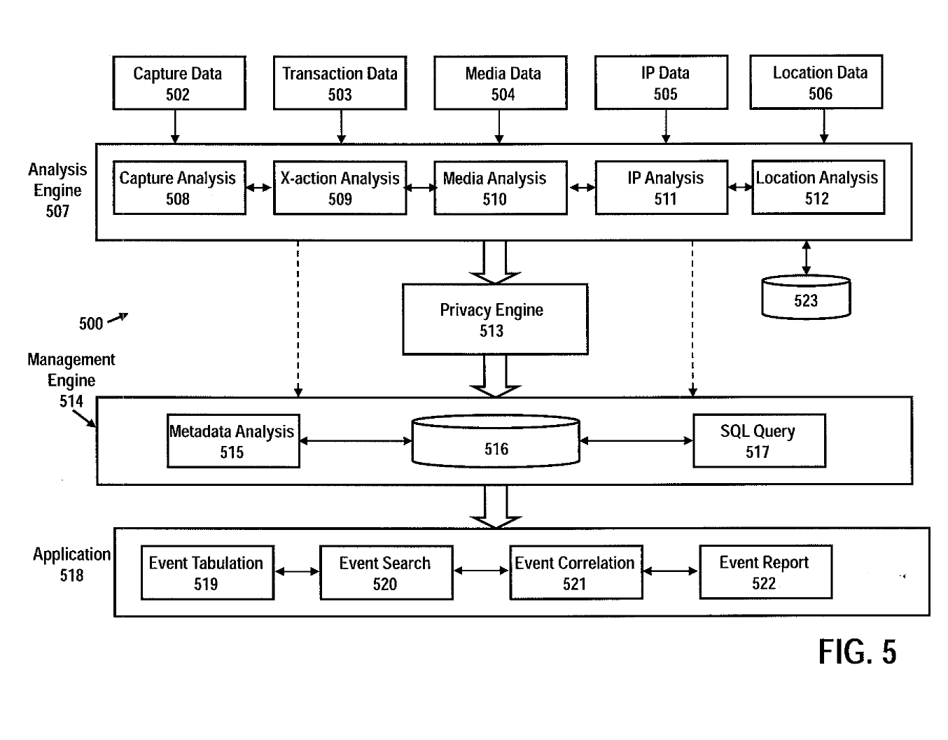

Turning to FIG. 5, and exemplary embodiment of a processing system is provided for collecting, processing and correlating data for marketing purposes. Under a preferred embodiment, participants may register with a marketing organization and provide individual and demographic data relating to each individual participant and related family members. Alternately, such data may be independently obtained from 3^{rd} party sources, Participants would provide one or more reference images for facial recognition purposes, along with other related data such as IP addresses or MAC addresses, set-top-box identification data, cell phone and/or telephone number, membership or rewards identification numbers registered with retailers, social network accounts and so on. This data would then be stored in storage 523. As an individual or participant engages in various activities, briefly discussed above in connection with FIG. 1, these activities would be registered and entered into system 500. More specifically, facial data captured from digital cameras 502 (see 100A-100C), transaction data 503 registered from POS terminals and the like (102), media data 504 captured from audience measurement devices (111, 112) and/or set-top boxes (106), IP data 505 (or “clickstream data”) captured from participant computers, laptops, or other portable devices (105, 112), and location data 506 are received in analysis engine 507. In the case of location data 506, the location data may be obtained from global positioning system (GPS) tracking, for example from a cell phone, or from fixed location data transmitted from a particular location. As an example, the fixed location data may be included in data transmitted from a store, which would include individual location points therein (e.g., location of digital signage kiosk, location of camera, etc.).

When any of the data from 502-506 is received in analysis engine 507, the engine performs capture analysis 508 on data 502, transaction analysis 509 on data 503, media analysis 510 on data 504, IP analysis on data 505 and location analysis 512 on location 506 and finds correlations and links between any of the data for marketing purposes. If participant data is registered in storage 523, the data is accessed to quickly compute correlations for a particular participant, and among multiple participants grouped according to a predetermined demographic characteristic. As all of the data from 502-506 is preferably time stamped, the analysis from engine 507 may be used to generate periodic reports on participant activity. In an alternate embodiment, other biometric data, such as signature/handwriting, fingerprint, eye scan, etc. may be incorporated as part of capture data 502. This biometric data may be linked to other capture data 502 and well as data 503-506 in the system of FIG. 5.

Privacy engine 513 is preferably used in the system to protect the identity of participants. Alternately, data from analysis engine 507 may be directly forwarded to management engine 514 (indicated by dashed arrows in FIG. 5) for report processing and generation, if privacy is not a concern. In this example, privacy engine 513 serves to edit and/or encrypt participant data that may serve to identify a particular participant. When data is edited, personal information is removed or obscured from the data to the extent that the resulting data will be insufficient to trace personal information to a particular user, while still retaining an identity for the user for the purposes of the market study. In other words, data may be edited to allow “blind matching” of data, so that the system will know that person “A1B1” identified in retail store “A” (502) viewed digital signage “B”, and made purchases“A2B2” in store “A” (503) and is further associated with viewer “B2A2” who was registered as watching program “X” (504) prior to visiting store “A”. Privacy engine may also receive and/or recode incoming video to institute scrambling and/or blocking, and may also provide keys for subsequent decryption, as described above in connection with FIGS. 3A-3B. Additional privacy features may be instituted such as those disclosed in U.S. Pat. No. 7,729,940, titled “Analyzing Return of Investments of Advertising Campaigns by Matching Multiple Data Sources” which is incorporated by reference in its entirety herein.

Privacy engine 513 can also be arranged to enhance privacy of facial images and other biometric information when it is incorporated with 3^{rd} party systems. In this embodiment, privacy engine 513 can provide cryptographic privacy-enhancements for facial recognition, which allows hiding of the biometric data as well as the authentication result from the server(s) that performs the matching. Such a configuration is particularly advantageous, for example, where the system of FIG. 5 is providing facial images to a 3^{rd} party that owns databases containing collections of face images (or corresponding feature vectors) from individuals. In one embodiment, an eigenface recognition system may be used on encrypted images using an optimized cryptographic protocol for comparing two encrypted values. Captured facial images may be transformed into characteristic feature vectors of a low-dimensional vector space composed of eigenfaces. The eigenfaces are preferably determined through Principal Component Analysis (PCA) from a set of training images, where every face image is represented as a vector in the face space by projecting the face image onto the subspace spanned by the eigenfaces. Recognition would be done by first projecting the face image to the low-dimensional vector space and subsequently locating the closest feature vector. In this embodiment, data would be protected using semantically secure additively homomorphic public-key encryption, such as Pailliere encryption and Damgård, Geisler and Krøigaard cryptosystem (DGK). Further details regarding this arrangement may be found in Erkin et al., “Privacy-Preserving Face Recognition,” Privacy Enhancing Technologies (PET'09), Vol. 5672 of LNCS, pages 235-253, Springer, 2009 and Sadeghi et al., “Efficient Privacy-Preserving Face Recognition,” 12th International Conference on Information Security and Cryptology (ICISC09), LNCS, Springer, 2009.

Database engine 514 can include or be part of a database management system (DBMS) uses to manage incoming data. Under a preferred embodiment, engine 514 is based on a relational database management system (RDMS) running on one or more servers to provide multi-user access and further includes an Application Programming Interface (API) that allows interaction with the data. Data received from analysis engine 507 (either directly or via privacy engine 513) is stored in 516 preferably in an extensible markup language (XML) formal. It is understood by those skilled in the art that other formats may be used as well.

In the example of FIG. 5, metadata analysis module 515 aggregates metadata and other related data from the multiple sources (502-506) and indexes them into predefined tables, which allows the system to provide more efficient searching 517 and identification of correlated events. Various types of query, retrieval and alert notification services may be structured based on the types of metadata available in the database storage 516. Application layer 518 allows a marketing entity to tabulate events 519 and search events 520 in order to establish event correlations 521. When one or more event correlations are determined, an event report generator 522 issues a report for a specific study.

Using the aforementioned techniques, data may be securely combined from multiple sources, perhaps provided in different formats, timeframes, etc., to produce various data describing the conduct of a study participant or panelist as data reflecting multiple purchase and/or media usage activities. This enables an assessment of the correlations between exposure to advertising and the shopping habits of consumers. Data about panelists may be gathered relating to one or more of the following: panelist demographics; exposure to various media including television, radio, outdoor advertising, newspapers and magazines; retail store visits; purchases; internet usage; and panelists' beliefs and opinions relating to consumer products and services. This list is merely exemplary and other data relating to consumers may also be gathered.

Third-party datasets utilized in the present system may be produced by different organizations, in different manners, at different levels of granularity, regarding different data, pertaining to different timeframes, and so on. Under preferred embodiments, such data may be integrated from different datasets or alternately converted, transformed or otherwise manipulated using one or more datasets. Datasets providing data relating to the behavior of households are converted to data relating to behavior of persons within those households. Preferably, datasets are structured as one or more relational databases and data representative of respondent behavior is weighted. Examples of datasets that may be utilized include the following: datasets produced by Arbitron Inc. (hereinafter “Arbitron”) pertaining to broadcast, cable or radio (or any combination thereof); data produced by Arbitron's Portable People Meter System; Arbitron datasets on store and retail activity; the Scarborough retail survey; the JD Power retail survey; issue specific print surveys; average audience print surveys; various competitive datasets produced by TNS-CMR or Monitor Plus (e.g., National and cable TV; Syndication and Spot TV); Print (e.g., magazines, Sunday supplements); Newspaper (weekday, Sunday, FSI); Commercial Execution; TV national; TV local; Print; AirCheck radio dataset; datasets relating to product placement; TAB outdoor advertising datasets; demographic datasets (e.g., from Arbitron; Experian; Axiom, Claritas, Spectra); Internet datasets (e.g., Comscore; NetRatings); car purchase datasets (e.g., JD Power); and purchase datasets (e.g., IRI; UPC dictionaries).

Datasets, such as those mentioned above and others provide data pertaining to individual behavior or provide data pertaining to household behavior. Currently, various types of measurements are collected at the household level, and other types of measurements are collected at the person level. For example, measurements made by certain electronic devices (e.g., barcode scanners) often only reflect household behavior. Advertising and media exposure, on the other hand, usually are measured at the person level, although sometimes advertising and media exposure are also measured at the household level. When there is a need to cross-analyze a dataset containing person level data and a dataset containing household level data, the dataset containing person level data may be converted into data reflective of the household usage, that is, person data is converted to household data. The datasets are then cross-analyzed.

Household data may be converted to person data in manners that are unique and provide improved accuracy. The converted data may then be cross-analyzed with other datasets containing person data. Household to person conversion (also referred to as “translation”) is based on characteristics and/or behavior. Person data derived from a household database may then be combined or cross-analyzed with other databases reflecting person data.

Databases that provide data pertaining to Internet related activity, such as data that identifies websites visited and other potentially useful information, generally include data at the household level, but may also include. That is, it is common for a database reflecting Internet activity not to include behavior of individual participants (i.e., persons). While some Internet measurement services measure person activity, such services introduce additional burdens to the respondent. These burdens are generally not desirable, particularly in multi-measurement panels. Similarly, databases reflective of shopping activity, such as consumer purchases, generally include only household data. These databases thus do not include data reflecting individuals' purchasing habits. Examples of such databases are those provided by IRI, HomeScan, NetRatings and Comscore.

The Abstract of the Disclosure is provided to comply with 37 C.F.R. §1.72(b) requiring an abstract that will allow the reader to quickly ascertain the nature of the technical disclosure. It is submitted with the understanding that it will not be used to interpret or limit the scope or meaning of the claims. The above description and figures illustrate embodiments of the invention to enable those skilled in the art to practice the embodiments of the invention. Thus the following claims are hereby incorporated into the Detailed Description, with each claim standing on its own as a separate embodiment.

What is claimed is:

1. A computer-implemented method for processing data in a tangible medium for a market study for a person having a market study identity, comprising the steps of:
receiving exposure data comprising data relating to a person's exposure to media in a plurality of different mediums during a period of the market study;
receiving transaction data comprising data relating to one or more commercial transactions attributed to the person during the period of the market study;
receiving image identification data comprising image data of the person, wherein the image data is received in a secure format that (i) prevents full reproduction of the image data or (ii) minimizing further identification of the person beyond the market study identity; and
correlating the exposure data, transaction data and image identification data to determine correlations between exposure to media and transactions attributed to the person.

2. The computer-implemented method of claim 1, wherein the plurality of different mediums of exposure data comprises at least two of television, radio, outdoor advertising, digital signage, newspapers and magazines, retail store visits, internet usage and panelists' beliefs and opinions relating to consumer products and services.

3. The computer-implemented method of claim 1, wherein the transaction data comprises at least one of credit card data, debit card data, shopper card data, telephone number, email address, home address and identification number.

4. The computer-implemented method of claim 1, where in the transaction data comprises data relating to a time in which the transaction data was generated compared to a time in which the image data was generated.

5. The computer-implemented method in claim 1, wherein the secure format for the image data comprises bit-scrambling a predetermined portion of the image data.

6. The computer-implemented method according to claim 5, wherein the bit-scrambling is formed by pseudo-random scrambling initialized by an encrypted seed value, wherein the encrypted seed value is inserted into the image data.

7. The computer-implemented method according to claim 1, further comprising the step of forming demographic data from the image identification data, said demographic data being formed by comparing the image identification data to one of (i) pre-stored image identification data relating to the panelist, and (ii) pre-stored image identification data relating to one or more demographic image characteristics relating to a census dataset.

8. The computer-implemented method according to claim 7, wherein the step of comparing image identification data comprises the comparison of coefficients extracted from the received image identification data to coefficients extracted from one of (i) pre-stored image identification data relating to the panelist, and (ii) pre-stored image identification data relating to one or more demographic image characteristics relating to a census dataset.

9. The computer-implemented method according to claim 1, wherein one or more of the exposure data and transaction data is formatted such that further identification of the person beyond the market study identity is minimized.

10. A computing system for processing data in a tangible medium for a market study for a person having a market study identity, comprising:
a processing apparatus;
a memory, operatively coupled to the processing apparatus; and
a communications input for (i) receiving exposure data comprising data relating to a person's exposure to media in a plurality of different mediums during a period of the market study, (ii) receiving transaction data comprising data relating to one or more commercial transactions attributed to the person during the period of the market study, and (iii) receiving image identification data comprising image data of the person, wherein the image data is received in a secure format that (a) prevents full reproduction of the image data or (b) minimizing further identification of the person beyond the market study identity;
wherein the processing apparatus correlates the exposure data, transaction data and image identification data to determine correlations between exposure to media and transactions attributed to the person.

11. The computing system of claim 10, wherein the plurality of different mediums of exposure data comprises at least two of television, radio, outdoor advertising, digital signage, newspapers and magazines, retail store visits, internet usage and panelists' beliefs and opinions relating to consumer products and services.

12. The computing system of claim 10, wherein the transaction data comprises at least one of credit card data, debit card data, shopper card data, telephone number, email address, home address and identification number.

13. The computing system of claim 10, where in the transaction data comprises data relating to a time in which the transaction data was generated compared to a time in which the image data was generated.

14. The computing system in claim 10, wherein the secure format for the image data comprises bit-scrambling a predetermined portion of the image data.

15. The computing system according to claim 14, wherein the bit-scrambling is formed by pseudo-random scrambling initialized by an encrypted seed value, wherein the encrypted seed value is inserted into the image data.

16. The computing system according to claim 10, wherein the processing apparatus generates demographic data from the image identification data, said demographic data being formed by comparing the image identification data to one of (i) pre-stored image identification data relating to the panelist, and (ii) pre-stored image identification data relating to one or more demographic image characteristics relating to a census dataset.

17. The computing system according to claim 16, wherein the comparing of image identification data by the processing apparatus comprises the comparison of coefficients extracted from the received image identification data to coefficients extracted from one of (i) pre-stored image identification data relating to the panelist, and (ii) pre-stored image identification data relating to one or more demographic image characteristics relating to a census dataset.

18. The computing system according to claim 10, wherein one or more of the exposure data, transaction data and image identification data is formatted such that further identification of the person beyond the market study identity is minimized.

19. A computer-implemented method for processing data in a tangible medium for a market study for a person having a market study identity, comprising the steps of:
receiving exposure data comprising data relating to a person's exposure to media in a plurality of different mediums during a period of the market study, said mediums comprising television, radio, outdoor advertising, digital signage, newspapers and magazines, retail store visits, internet usage and panelists' beliefs and opinions relating to consumer products and services;
receiving transaction data comprising data relating to one or more transactions attributed to the person during the period of the market study;
receiving image identification data comprising image data of the person, wherein the image data is received in a secure format that (i) allows only partial reproduction of the image data or (ii) minimizes further identification of the person beyond the market study identity;
confirming the market study identity of the person using the image identification data; and
correlating the exposure data, transaction data and image identification data to determine correlations between exposure to media and transactions attributed to the market study identity of the person.

20. The computer-implemented method of claim 19, wherein the secure format for the image data comprises bit-scrambling a predetermined portion of the image data.
